(19) United States
(12) Patent Application Publication
(10) Pub. No.: US 2002/0119285 A1
(43) Pub. Date: Aug. 29, 2002

(54) Process for making a seal and apparatus for sealing doublewide munufactured homes

(76) Inventors: Gregory A. Arnold, Auburndale, FL (US); Jamie C. Arnold, Auburndale, FL (US)

Correspondence Address: George A. Bode, BODE & ASSOCIATES, P.C., 2314 Broadway, New Orleans, LA, 70125-4128, US

(21) Appl. No.: 10/122,937

(22) Filed: Apr. 12, 2002

Related U.S. Application Data
(63) Continuation-in-part of application No. 09/880,221, filed on Jun. 13, 2001.
Application No. 09/880,221 is a division of application No. 09/645,149, filed on Aug. 24, 2000, now Pat. No. 6,245,179.
Application No. 09/645,149 is a division of application No. 09/428,860, filed on Oct. 28, 1999, now Pat. No. 6,110,312.
Application No. 09/428,860 is a continuation-in-part of application No. 08/999,198, filed on Dec. 29, 1997, now abandoned.
Application No. 08/999,198 is a division of application No. 08/684,997, filed on Jul. 22, 1996, now Pat. No. 5,720,146.

(51) Int. Cl. B32B 3/00

(52) U.S. Cl. 428/119; 428/71

(57) ABSTRACT

A seal for doublewide or multi-section manufactured homes that creates “semi-rigid” or “semi-stiff” flanges on sides of a covered sealing foamed material. The “semi-rigid” or “semi-stiff” flanges are created by simulating lamination of top and bottom halves of a flexible polymer sheet on sides of the sealing foamed material. Thereby, eliminating rolling and curling of the ends of the flanges. Furthermore, the lamination creates a seamless (solid) vapor barrier between the foamed material and the longitudinal side of the flexible polymer sheet.

### CROSS-REFERENCE TO RELATED APPLICATIONS

This application is a continuation-in-part of a previous application by the same inventors bearing U.S. patent application Ser. No. 09/880,221, filed, Jun. 11, 2001, which is a division of U.S. patent application Ser. No. 09/645,149, filed Aug. 24, 2000 (now U.S. Pat. No. 6,245,179, issued Jun. 12, 2001), which is a division of U.S. patent application Ser. No. 09/428,860, filed Oct. 28, 1999 (now U.S. Pat. No. 6,110,312, issued Aug. 29, 2000), which is a continuation-in-part of U.S. patent application Ser. No. 09/999,198, filed Dec. 29, 1997 (now abandoned), which is a division of U.S. patent application Ser. No. 08/684,997, filed Jul. 22, 1996 (now U.S. Pat. No. 5,720,146, issued Feb. 24, 1998). Applicants claim the benefit, under 35 U.S. Code, Section 120, of the following U.S. patent application Ser. No. 09/880,221, filed, Jun. 11, 2001; U.S. patent application Ser. No. 09/645,149, filed Aug. 24, 2000 (now U.S. Pat. No. 6,245,179, issued Jun. 12, 2001); U.S. patent application Ser. No. 09/428,860, filed Oct. 28, 1999 (now U.S. Pat. No. 6,110,312, issued Aug. 29, 2000); U.S. patent application Ser. No. 08/999,198, filed Dec. 29, 1997 (now abandoned); U.S. patent application Ser. No. 08/684,997, filed Jul. 22, 1996 (now U.S. Pat. No. 5,720,146, issued Feb. 24, 1998). The entirety of each of these previous applications is incorporated herein by reference as if set forth in full below.

### BACKGROUND OF THE INVENTION

1. Field of the Invention

The present invention relates to a process for sealing doublewide manufactured homes and modular homes sections together and especially to a process of making a sealing material having a thick foamed polymer material wrapped with a flexible polymer material to create a solid vapor barrier.

2. General Background

Manufactured homes are those in which a home or building is manufactured at a central location or factory where it can then be loaded onto a tractor-trailer and hauled to a purchaser's home site. At the home site, the manufactured home can be mounted onto a prepared foundation. Manufactured homes, in contrast to custom homes, have the advantages of mass production at one factory site where they can obtain the benefits of volume purchasing, more efficient assembly through standard jigs, fixtures, and machinery, and can have a more advanced engineering design. One of the problems with manufactured homes has been in making a home of a size and shape that can be hauled over a highway. This limits the width of the home and thus limited the homes to smaller elongated units. To overcome this limitation, double wide manufactured homes were developed which use a pair of manufactured home sections, each of which can be the same size as on manufactured home but without one wall so that doublewide manufactured home sections can be individually hauled to a home site where the two sections can be brought together and attached to form a manufactured home which does not have the customary elongated shape of a typical manufactured home. This allows for larger homes which can have additional design features to make the home look more like a custom home.

In recent years, doublewides have become increasingly popular but have also had various problems attached with them including the proper attachment of the doublewide sections together to form one unit which attachments must appear seamless and at the same time need to be well sealed from the exterior weather elements. Common doublewides today are attached together and are caulked around the perimeter of the attaching centerline or, alternatively, are shot with an expanding polymer caulk to seal the perimeter. One of the difficulties is sealing a pair of doublewides is that the seam around the attached sections tends to vary in width on the outside so that conventional caulk is not always satisfactory and expanding foam tends to weather and does not always give a weatherproof seal.

The present invention improves the sealing in doublewide manufactured homes along the perimeter of the attached sections which not only gives a good seal against the weathering elements but also will not deteriorate in the manner of other materials currently being used.

Prior art sealing strips for forming a variety of seals but not seals for manufactured home doublewides, can be seen in the U.S. Pat. No. 4,084,348 to Hast, for a sealing strip which has a cylindrical shape having a resilient core of foamed plastic surrounded by a foil of PVC or polyethylene and an outer covering of textile fabric and in which the outer covering and the foil are attached together to form a flange which also has a adhesive strip attached thereto. The L. N. Williams et al. U.S. Pat. No. 3,170,967 and R. A. Footner U.S. Pat. No. 3,413,389, each teach a method of making a sealing strip using a polyvinyl foam having a polyvinyl resin skin outer layer. In the Burkhalter U.S. Pat. No. 2,827,280, a resilient bumper is made of a cylindrical rubber resilient core having a tubular sheath closure and which are attached together with a grommet therebetween. These prior art seals are not suitable for use in sealing doublewide sections which requires a much thicker sealing strip with greater flexibility and with a more flexible cover in order to be able to give a seal with wide variations in the spacing between the double wise sections at different points around the perimeter of the assembled doublewide home.

In an attempt to create a solid vapor barrier between the polypropylene and the foam, ultrasonic frequency bonding was used to bond the layers of the flanges. While the layers were somewhat bonded, a solid vapor barrier was not achieved. In a second attempt to create a solid vapor barrier, a heat adhesive was used to bond the flange layers together. Such a heat adhesive has proven successful.

It is accordingly an object of the present invention to provide a process of sealing doublewide manufactured home sections together with a selected sealing material custom formed for sealing doublewides which can be rapidly attached to one section of the doublewide before the doublewide sections are attached together. A polyurethane polymer of approximately 1.2 density is enclosed with a polypropylene which is attached with one edge folded over the other and bonded or laminated together to form laminated “semi-stiff” flanges giving greater strength to the flanges.

A further object is to provide a seel with a peel-off self-adhesive layer on the bottom of the flanges and/or base layer thereof to adhesively affix the seal to one section rapidly.

### SUMMARY OF THE PRESENT INVENTION

Broadly, the present invention contemplates a seal for a doublewide or multi-sectioned manufactured home comprising: a means for sealing sections of the manufacture home; and, a means for covering said sealing means wherein the covering means is divided into a bottom section and a top section. The seal further includes a means for affixing the sealing means to the bottom section of the covering means, and laminating the top section to the bottom section on sides of the sealing means to form first and second semi-stiff flanges extending along side of said sealing means.

The present invention contemplate a seal with first and second seamless and solid vapor barriers between the bottom section and the top section at bottom longitudinal sides of the sealing means.

The present invention still further contemplates a seal that includes a means for self-adhesively affixing a bottom surface of said bottom section to a support surface during installation.

Additionally, the present invention contemplates a method of forming a seal for a doublewide or multi-sectioned manufactured home comprising the steps of: applying molten glue layer along an upper surface of a base of polypropylene; bonding an elongated foamed polymer core along a longitudinal center of said base via said molten glue layer; wrapping a portion of the polypropylene over said base and said foamed polymer core; simultaneously with the wrapping step, bonding said polypropylene to remaining portions of said base to form first and second semi-stiff flanges extending along side of said foamed polymer core.

The above and other objects and features of the present invention will become apparent from the drawings, the description given herein, and the appended claims.

### BRIEF DESCRIPTION OF THE DRAWING

For a further understanding of the nature and objects of the present invention, reference should be had to the following description taken in conjunction with the accompanying drawings in which like parts are given like reference numerals and, wherein:

FIG. 1 is a flow diagram of a process of attaching doublewide manufactured home sections in accordance with the present invention;

FIG. 2 is a sectional view taken through the sealing material used in the present invention;

FIG. 3 is a perspective view of a roll of sealing material having the end being rolled off of a spool for measuring and cutting;

FIG. 4 is a side elevation of a doublewide manufacturing home section having the present sealing material attached;

FIG. 5 is a partial side elevation of a pair of doublewide sections being brought together;

FIG. 6 is a perspective view of another embodiment of sealing material for sealing doublewide manufactured homes;

FIG. 7 is a sectional view taken through sealing material of FIG. 6;

FIG. 8 is a perspective view of second embodiment of sealing material for sealing doublewide manufactured homes;

FIG. 9 is a sectional view taken through sealing material of FIG. 8; and,

FIG. 10 is a flow diagram of a process of making the sealing material in accordance with the present invention.

### DETAILED DESCRIPTION OF THE PREFERRED EMBODIMENT

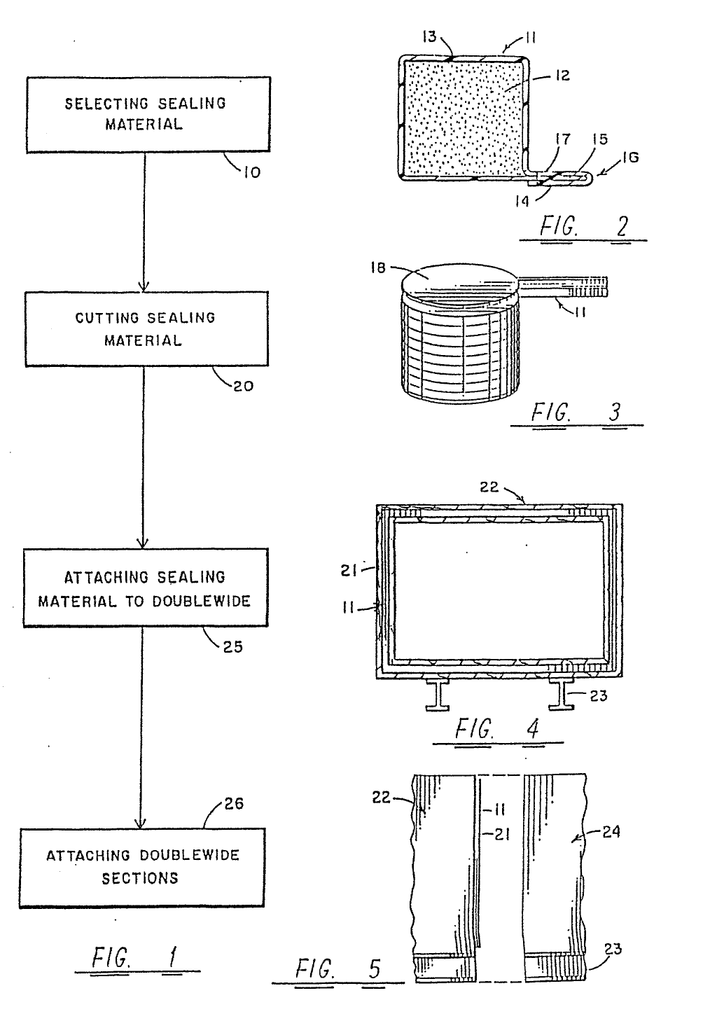

Referring now to the drawing and in particular FIGS. 1-5, a process of sealing a pair of doublewide manufactured home sections together is illustrated in which the first step is selecting the sealing material of FIG. 1. The selected material, as shown in FIG. 2, is a foamed polymer, such as polyurethane, having a 1.2 density to allow greater flexibility in conforming to a sealing shape. In FIG. 2, the cross-section shows that the foamed polymer 12 has an approximately square shape and has a cover 13 wrapped therearound. The cover is made of a polypropylene, which may have an ultraviolet blocking material incorporated therein. The polypropylene has the advantages of being a very flexible material resistant to weathering elements and not subject to the break-up that might result to the polyurethane foam 12. In addition, it can be sewn together and provides the needed flexibility since the cover 13 is not attached to the foam 12 but is merely wrapped therearound with the edges attached together.

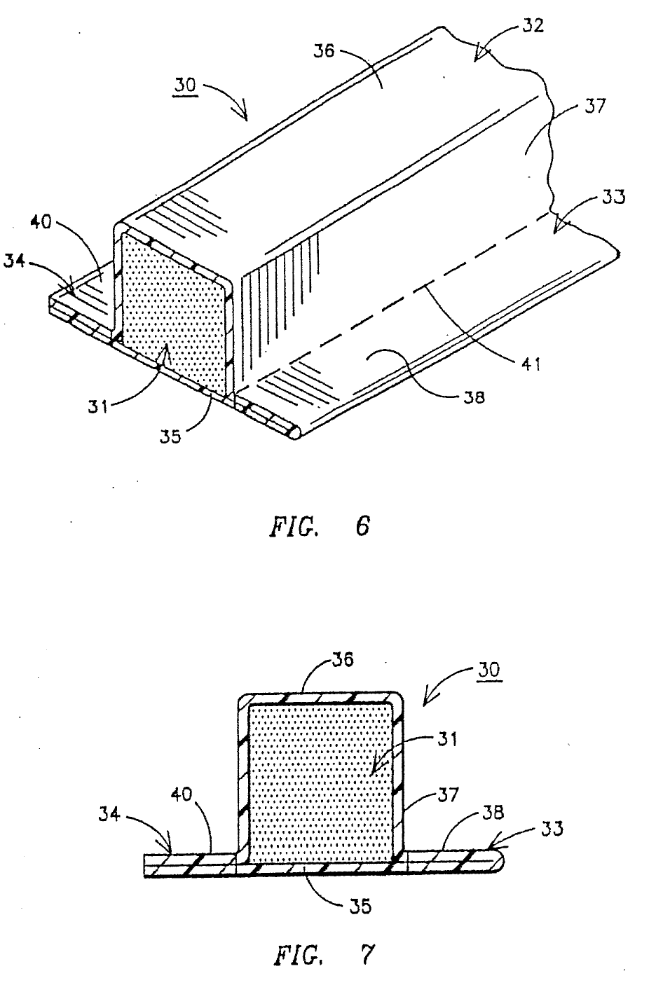

As seen in FIG. 2 one folded edge 14 of the material 13 has a second folder edge 19 and has been folded over and around the two edges 15 of the material 13, after being wrapped around the foamed polyurethane core 12. The attachment of the flexible wrapping material in this manner provides a flange 16 having six layers of polypropylene covering material which is sewn with the stitches 17 through the six layers which thereby seals the material around the foamed polymer core 12 and holds the flange together with one stitched line located adjacent the foamed core material 12. This material can advantageously be prepared in large or smaller quantities and can then be packaged on large spools or drums 18, as shown in FIG. 3, where the material 11 can be reeled off the drum 18 where it can be measure and cut in accordance with the step 20 of the process of FIG. 1.

Once the material is cut from the spool 18, the flange 16 can be stapled through the six layers of the flange to the attaching wall section 20 of a doublewide manufactured home section 22, which is shown in FIG. 4 supported on a pair of I-beams 23. The sealing strip 11 is attached around the perimeter of the doublewide section 22 so that when a pair of doublewide sections 22 and 24 are attached with the sealing material therebetween.

The doublewide sections 22 and 24 are brought together while supported on an I-beam 23 and are attached together to form one doublewide manufactured home. The attachment of the sealing material strip 25 to the doublewide section can be accomplished in any way desired but powered staplers provide a convenient means and, because of the strength of the polypropylene formed in six layers in the flange, a secure attachment can be accomplished.

The seal can be attached at the factory or on site during the assembly of the doublewide sections 22 and 24 where the seals are conventionally added to the doublewide sections. The attaching of the doublewide sections strip 26 can be rapidly accomplished and because of the thickness of the foamed polyurethane 12 forming the sealing material and because of the amount of air incorporated into the polyurethane to provide a density of 1.2. The polyurethane can be compressed and expanded with great flexibility over wide variations into the sealing gap. The polyurethane foamed material may be of a thickness of 2.54 centimeters or greater. The seal tends to seal any space between the doublewide sections from a very tight fit up to a 3.8 centimeter space to thereby tightly seal between the doublewide sections to prevent the intrusion of weather elements as well as to block the ingress of insects or the like.

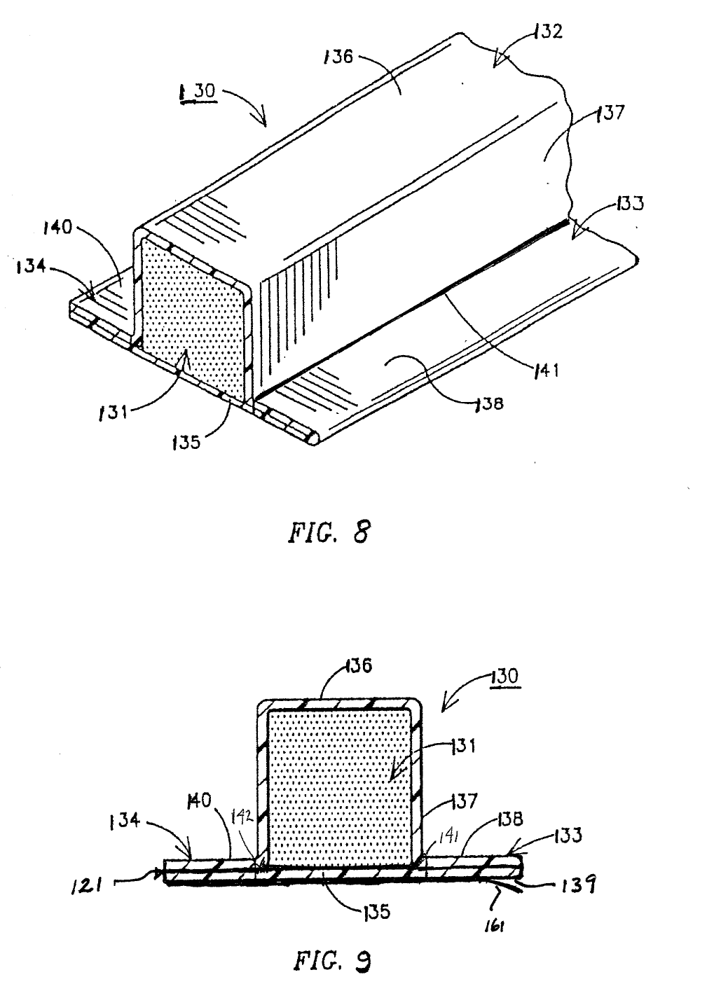

Turning now to FIGS. 6 and 7, a second embodiment of the sealing material 30 is illustrated having a foamed polymer material 31, such as a polyurethane having a 1.2 density to allow great flexibility in conforming to a sealing shape. The foamed polymer 31 is covered with a flexible skin 32 made of a polypropylene having an ultraviolet blocking material incorporated therein. The skin 32 is formed, such as to have a folded flange 33 on one side and a folded flange 34 on the other side thereof. The skin 32 has a base 35 forming a bottom of the folded flanges 33 and 34 and a top skin 36, a pair of side skins 37. The flange 33 has a top flange portion 38 and the flange 34 has a top flange portion 40. The folded flange portions 33 and 34 are held in the folded position by sewing the upper and lower flange portions together with a thread 41 but can also be hold together with an adhesive which is flexible when cured. The seal 30 can then be stapled through both flanges for sealing the area between a doublewide and holding the foamed polymer 31.

The sealing material 30 can be easily manufactured by having a piece of foamed polymer material 31 which can be of a generally square shape as illustrated, covered with a loose flexible sleeve of polypropylene, which is considerably larger than the perimeter of the foamed cover material 31, such that the material can be folded down to form a flexible but tight skin over the foamed polymer 31 and the slack material forming two equal flanges 38 and 40 of folded polymer material which can then be sewn together so that the flexible skin tightly fits around the foam center 31 while providing two reinforced flanges. The flanges can be used for stapling both sides of the seal to one side of a doublewide manufactured home.

It should be clear that the embodiment of FIGS. 6 and 7 improves the ease of manufacturing of a sealing material and at the same time, provides a greater support of the material to the doublewide by having a reinforced flange on either side which can be stapled on both sides. However, the present invention should not be limited to the forms shown which are to be considered illustrative rather than restrictive.

Referring now to FIGS. 8 and 9, the third embodiment of the sealing material 130 is shown. The sealing material 130 includes a foamed polymer material 131, such as a polyurethane having a 1.2 density to allow great flexibility in conforming to a sealing shape. The foamed polymer 131 is covered with a flexible skin 132 made of a polypropylene having an ultraviolet blocking material incorporated therein. The skin 132 is formed, such as to have a folded semi-rigid flange 133 on one side and a folded semi-rigid flange 134 on the other side thereof. The skin 132 has a base 135 forming the bottom sheeting of the folded semi-rigid flanges 133 and 134 and a top skin 136 forming a pair of side skins 137 and the top flange portion 138 and 140 of flanges 133 and 134, respectively.

The semi-rigid flange 133 has a top flange portion 138 and the flange 134 has a top flange portion 140. The top flange portion 138 of semi-rigid flange 133 and the top flange portion 140 of flange 134 are affixed to the top surface of the bottom sheeting (base 135) by molten glue. The molten glue layer 121 stiffens the flexible skin 132 so that the flanges 133 and 134 are “semi-rigid” or “semi-stiff.”

The terms “semi-rigid” and “semi-stiff” means that the material does not collapse or bend under gravity. However, the semi-rigid flanges 133 and 134 will flex. The “semi-rigid” and “semi-stiff” properties are created by the three layers, the top flange portions 138, 140, the base 135 and the molten glue layer 121, the molten glue layer 121 bonding the top flange portions 138, 140 to the base 135 on opposite sides of the foamed polymer material 131 wherein seamless (solid) vapor barriers 141, 142 are created between the base 135 and the skin 132 on opposite sides of the foamed polymer material 131.

The terms “semi-rigid” and “semi-stiff” means that the material does not collapse or bend under gravity. However, the semi-rigid flanges 133 and 134 will flex.

In this embodiment, the foamed polymer material 131 is affixed to the bottom sheeting (base 135) via the molten glue so that it is stationary and does not shrink.

In operation, when applying the sealing material 130 to mate a doublewide manufactured home or multi-section manufactured home, staples are stapled through both flanges 133 and 134 to holding or affixing the foamed polymer 131 between sections of the doublewide or multi-section manufactured home, thus sealing the mated centerline connection.

Because the flanges 133 and 134 are “semi-rigid” or “semi-stiff,” the application of the sealing material 130 is quick and easier whereby, the “semi-rigid” or “semi-stiff” property serves to maintain the flanges 133 and 134 radiating straight out from the base of the foamed polymer material 131. Moreover, because the top flange portions 138, 140 are bonded to the base 135, the longitudinal edges of the top flange portion 140 and the base 135 do not generally curl or roll (as does flange portions 38 and base 35) which would require the installer to mat down the curled edges to properly staple the flange 134. Furthermore, the “semi-rigid” or “semi-stiff” properties creates a “semi-rigid” or “semi-stiff” base 135 that lays flat on a support surface (whether horizontal or vertical) to position the sealing material 130 about the centerline joining sections.

As can be readily seen the flanges 133 and 134 are laminated in that they includes a portion of base 135, a portion of the molten glue layer 121 and a portion of the top flange portions 138, 140.

Furthermore, the flat “semi-still” flange 133 or 134 can be quickly secured to one of the sections of the doublewide or multi-section manufactured. An when affixing the other flange to the other section, the base 135 and such flange lie flat and are ready to be affixed.

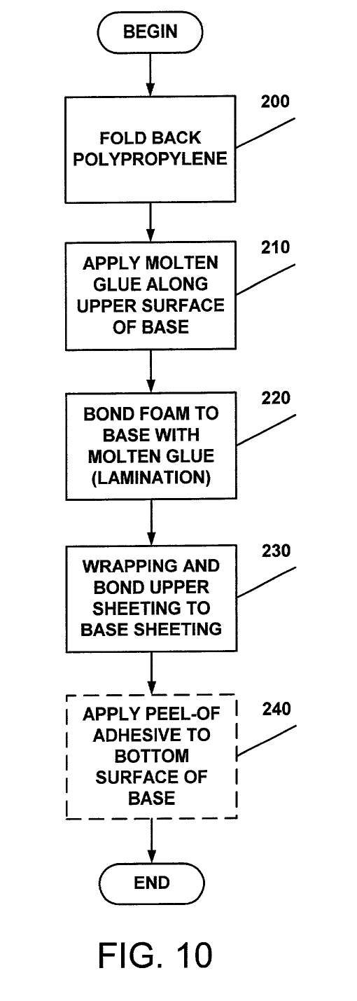

Referring also to FIG. 10, the method of making the sealing material 130 begins with the Step 200. Step 200 includes folding back the polypropylene. Step 200 is followed by Step 210 where the molten glue is applied to the upper surface of base 135. Step 210 is followed by Step 220 where the foam material 131 is bonded to the center of the upper surface of base 135 via the molten glue. Step 220 is followed by Step 230 where the flexible skin 132 is wrapped around the base 135 to form the flange 133, flange 134 and cover foam material 131. During the wrapping and bonding applying pressure to the flexible skin 132 along the bottom sides of the foam material's base creates the seamless solid vapor barriers 141 and 142 as the flexible skin 132 adheres to base 135 via the molten glue layer 121.

The process described above laminates the flanges 133 and 134 to create the “semi-rigid” and “semi-stiff” properties. Furthermore, the portion of the base 135 having the foam material 131 has a likewise “semi-stiff.”

Referring also to FIG. 9, optionally, Step 230 may be followed by Step 240 (shown in phantom) where the peel-off self-adhesive 139 is secured to the bottom surface of base 135. Therefore, when installing the sealing material 130, the peel-off-cover 161 of the peel-off self-adhesive 139 is removed and the self-adhesive 139, a layer on the bottom surface of base 135, affixes the sealing material 130 to the centerline of mated sections. On the other hand, the peel-off self-adhesive 139 can be used to affix the sealing material 130 to the centerline without the need for stapling (stapling is not necessary with the optional peel-off self-adhesive 139 on the bottom of the flanges, but is necessary without it).

The Step 200 may be preceded by the following steps: selecting a portion of polypropylene forming the skin 132; dividing the portion of skin 132 substantially in half about the longitudinal center into a top (half) skin 136 and a bottom half, the bottom half forming the base 135; and, folding back the top (half) skin 136.

It should be noted that the Step 210 of applying molten glue includes heating the molten glue in a liquid to 280 degrees Fahrenheit (280° F.).

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

What is claimed as invention is:

1. A method of forming a seal for a doublewide or multi-sectioned manufactured home comprising the steps of:
applying molten glue layer along an upper surface of a base of polymer sheet;
bonding an elongated foamed polymer core along a longitudinal center of said base via said molten glue layer;
wrapping a portion of the polymer sheet over said base and said foamed polymer core;
simultaneously with the wrapping step, bonding said polymer sheet to remaining portions of said base to form first and second semi-stiff flanges extending along side of said foamed polymer core.

2. The method according to claim 1, wherein the bonding step includes:
creating first and second seamless and solid vapor barriers between said base and said portion at bottom longitudinal side of said foam polymer core.

3. The method according to claim 1, further comprising, prior to the applying step, the steps of:
selecting a section of said polymer sheet;
dividing said section substantially in half about the longitudinal center into a top half and a bottom half, the bottom half forming said base; and,
folding back said top half.

4. The method according to claim 1, wherein the applying step further comprises the step of:
heating said molten glue in a liquid to 280 degrees Fahrenheit.

5. The method according to claim 1, further comprising the step of:
affixing a peel-off self-adhesive to a bottom surface of said base.

6. A method according to claim 1, wherein:
said polymer sheet comprises polypropylene and an ultraviolet blocking material.

7. The method according to claim 1 wherein said foamed polymer core is an elongated strip of polyurethane having a density of approximately 1.2.

8. A seal for a doublewide or multi-sectioned manufactured home comprising:
an elongated polymer foamed core having a top and a base and two sides;
an elongated polymer sleeve comprising:
a flexible skin forming a base layer and a top layer;
a molten glue layer disposed over said base layer,
wherein:
said top layer is wrapped around said top and said two side of said foamed core and affixed to said base layer via said molten glue;
the affixing forms an elongated semi-stiff flange on each side of said foamed core and first and second seamless and solid vapor barriers; and,
said semi-stiff flanges are adapted to be affixed to the doublewide or the multi-section manufactured home.

9. The seal according to claim 8, wherein said base of said foamed core is affixed about a center of said base layer via said molten glue layer.

10. The seal according to claim 8, wherein said polymer sleeve is a polypropylene and ultraviolet blocking material.

11. The seal according to claim 8, wherein said elongated foamed polymer core is an elongated strip of polyurethane having a density of approximately 1.2.

12. The seal according to claim 8, further comprising:
a peel-off self-adhesive layer affixed to a bottom surface of said base wherein during installation, a peel-off-cover is removed and the self-adhesive layer is adapted to be affixed to a support surface.

13. The seal according to claim 8, wherein each semi-stiff flange comprises:
a portion of said base;
a portion of said molten glue layer disposed over said portion of said base; and,
a portion of said top layer disposed over the molten glue layer portion.

14. A seal for a doublewide or multi-sectioned manufactured home comprising:
means for sealing sections of the manufacture home;
means for covering said sealing means wherein the covering means is divided into a bottom section and a top section; and,
means for affixing the sealing means to the bottom section of the covering means and laminating the top section to the bottom section on sides of the sealing means to form first and second semi-stiff flanges extending along side of said sealing means.

15. The seal according to claim 14, wherein the means for affixing creates first and second seamless and solid vapor barriers between said bottom section and said top section at bottom longitudinal side of said sealing means.

16. The seal according to claim 14, wherein said covering means comprises a polypropylene and ultraviolet blocking material.

17. The seal according to claim 14, wherein said sealing means comprises: an elongated foamed polymer core.

18. The seal according to claim 17, wherein said foamed polymer core is an elongated strip of polyurethane having a density of approximately 1.2.

19. The seal according to claim 14, further comprising:
means for self-adhesively affixing a bottom surface of said bottom section to a support surface during installation.

20. A process for sealing doublewide or multi-section manufactured homes comprising the steps of:
selecting a sealing material having elongated polymer foam wrapped in flexible material which flexible material forms first and second semi-stiff flanges on opposite longitudinal side of said foam;
cutting a length of said selected sealing material;
adhesively attaching said first semi-stiff flange of said cut sealing material around the perimeter of one attaching side of said manufactured home; and,
attaching a pair of sections of said manufactured home together via the second semi-stiff flange of said cut sealing material to seal the perimeter between the pair of sections.

21. The process according to claim 20, further comprising the step of:
after the adhesively attaching step, stapling said first semi-stiff flange; and,
during said attaching of the pair of sections step,
stapling said second semi-stiff flange.

22. The process according to claim 20, wherein the elongated polymer foam comprises an elongated strip of polyurethane having a density of approximately 1.2.

23. The process according to claim 20, wherein said flexible material is a polypropylene and ultraviolet blocking material.
